(19) United States
(12) Patent Application Publication
(10) Pub. No.: US 2022/0012492 A1
(43) Pub. Date: Jan. 13, 2022

(54) OBJECT DETECTION DEVICE

(71) Applicant: DENSO CORPORATION, Kariya-city (JP)

(72) Inventors: Jian Kang, Nisshin-city (JP); Mitsutoshi Morinaga, Kariya-city (JP)

(21) Appl. No.: 17/483,647

(22) Filed: Sep. 23, 2021

Related U.S. Application Data
(63) Continuation of application No. PCT/JP2020/013599, filed on Mar. 26, 2020.

(30) Foreign Application Priority Data
Mar. 27, 2019 (JP) 2019-060887

(51) Int. Cl. G06K 9/00; G06T 7/73; G06T 7/62

(52) U.S. Cl. CPC G06K 9/00624; G06T 2207/20021; G06T 7/62; G06T 7/74

(57) ABSTRACT

An object detection device includes a region measurement unit, a region acquisition unit, a region determination unit, and an object detection unit. The region measurement unit measures, based on the detection result from at least one first sensor for detecting at least the azimuth of an object, at least an azimuth range in which the object exists, as an object-present region. The region acquisition unit acquires a common region that is the overlap between a detection region in which the first sensor can detect the position of the object and a detection region in which a plurality of second sensors for detecting the distance to an object can detect the position of the object. The region determination unit determines whether the object-present region and the common region overlap each other. When the object-present region and the common region overlap each other, the object detection unit detects the position of the object within the object-present region based on the distances detected by the second sensors between the second sensors and the object.

### CROSS-REFERENCE TO RELATED APPLICATION

This application is the U.S. bypass application of International Application No. PCT/JP2020/013599 filed on Mar. 26, 2020 which designated the U.S. and claims priority to Japanese Patent Application No. 2019-060887, filed on Mar. 27, 2019, the contents of both of which are incorporated herein by reference.

### TECHNICAL FIELD

The present disclosure relates to a technique for detecting the position of an object.

### BACKGROUND

An example technique for detecting the position of an object is described in JP 2014-44160 A. In the technique, two different sensor pairs in three or more sensors each measure the time difference of arrival of radio waves from an object, and the position of the object is detected based on the fact that the time difference of arrival for each pair is caused by the difference in distance between the sensors and the object.

### SUMMARY

An object detection device according to one aspect of the present disclosure includes a region measurement unit, a region acquisition unit, a region determination unit, and an object detection unit.

The region measurement unit measures, based on the detection result from at least one first sensor for detecting at least the azimuth of an object, at least an azimuth range in which the object exists, as an object-present region in which the object exists. The region acquisition unit acquires a common region that is the overlap between a detection region in which the first sensor can detect the position of the object and a detection region in which a plurality of second sensors for detecting the distance to an object can detect the position of the object. The region determination unit determines whether the object-present region measured by the region measurement unit and the common region acquired by the region acquisition unit overlap each other. When the region determination unit determines that the object-present region and the common region overlap each other, the object detection unit detects the position of the object within the object-present region based on the distances detected by the second sensors between the second sensors and the object.

### BRIEF DESCRIPTION OF THE DRAWINGS

The above features of the present disclosure will be made clearer by the following detailed description, given referring to the appended drawings. In the accompanying drawings:

FIG. 1 is a block diagram of an object detection device according to a first embodiment;

FIG. 2 is a flowchart of object detection processing;

FIG. 3 is a schematic diagram illustrating a first sensor detecting the azimuth of an object;

FIG. 4 is a diagram illustrating the common region between the detection region of the first sensor and the detection region of second sensors;

FIG. 5 is a schematic diagram illustrating object detection in an object-present region;

FIG. 6 is a block diagram of an object detection device according to a second embodiment;

FIG. 7 is a flowchart of object detection processing;

FIG. 8 is a schematic diagram illustrating object detection in a meshed object-present region;

FIG. 9 is a block diagram of an object detection device according to a third embodiment;

FIG. 10 is a diagram illustrating the common region between the detection region of first sensors and the detection region of second sensors;

FIG. 11 is a schematic diagram illustrating object detection in a meshed object-present region;

FIG. 12 is a schematic diagram illustrating an example of mesh division according to a fourth embodiment;

FIG. 13 is a schematic diagram illustrating another example of mesh division;

FIG. 14 is a schematic diagram illustrating an example of mesh division according to a fifth embodiment; and

FIG. 15 is a schematic diagram illustrating another example of mesh division.

### DETAILED DESCRIPTION OF THE PREFERRED EMBODIMENTS

When the position of an object is detected based on the time difference of arrival measured by the sensors of each pair, each sensor pair may measure a plurality of different time differences of arrival due to interference between a plurality of signals or noise caused in the receiver including the sensors.

In the technique described in JP 2014-44160 A, when each sensor pair measures different time differences of arrival, with respect to a reference sensor, the radio wave signals received by the other sensors are shifted by the time differences of arrival, and the inner product of the shifted radio wave signals is calculated. For radio wave signals having the correct time differences of arrival, when the radio wave signals are shifted by the time differences of arrival, the resulting signals are radio wave signals that arrive at the same time for each sensor pair. Thus, their inner product is higher than the inner product of radio wave signals having other time differences of arrival.

The technique described in JP 2014-44160 A is intended to detect the position of an object based on the time differences of arrival of a combination of highly correlated radio wave signals that provide a high inner product.

Furthermore, it is known that the distance to an object is detected with a plurality of second sensors, and an intersection point of circles with the centers at the second sensors and a radius of the measured distance is detected as the position of the object.

However, detailed research conducted by the present inventors has revealed that the technique described in JP 2014-44160 A has a heavy processing load because finding a combination of highly correlated radio wave signals needs calculation of the inner products of combinations of signals received by all sensor pairs.

In addition, when intersection points of circles with a radius of the distance to an object are extracted as candidate points for the position of the object, and the extracted candidate points are subjected to object detection processing, the execution of the object detection processing for all the candidate points causes a heavy processing load of the detection processing.

One aspect of the present disclosure desirably provides a technique for detecting the position of an object as little processing load as possible.

An object detection device according to one aspect of the present disclosure includes a region measurement unit, a region acquisition unit, a region determination unit, and an object detection unit.

The region measurement unit measures, based on the detection result from at least one first sensor for detecting at least the azimuth of an object, at least an azimuth range in which the object exists, as an object-present region in which the object exists. The region acquisition unit acquires a common region that is the overlap between a detection region in which the first sensor can detect the position of the object and a detection region in which a plurality of second sensors for detecting the distance to an object can detect the position of the object. The region determination unit determines whether the object-present region measured by the region measurement unit and the common region acquired by the region acquisition unit overlap each other. When the region determination unit determines that the object-present region and the common region overlap each other, the object detection unit detects the position of the object within the object-present region based on the distances detected by the second sensors between the second sensors and the object.

This configuration enables, based on the detection result from the first sensor, at least an azimuth range in which the object exists, to be defined as an object-present region in which the object exists. Then, when the object-present region overlaps the common region that is the overlap between the detection region of the first sensor and the detection region of the second sensors, the position of the object is detected within the object-present region based on the distance detected by each of the second sensors between the second sensor and the object.

This method obviates the need for detecting the position of the object outside the object-present region within the detection region of the second sensors based on the distances detected by the second sensors. This allows a reduction in the processing load of detecting the position of the object based on the distances detected by the second sensors.

Embodiments of the present disclosure will now be described with reference to the drawings.

### 1. First Embodiment

### [1-1. Configuration]

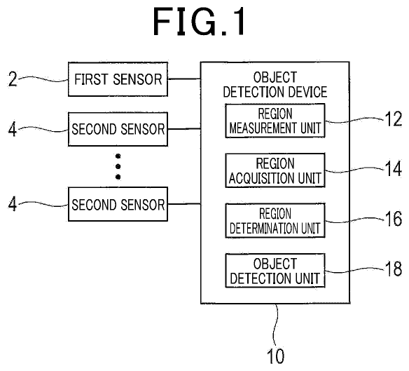

An object detection device 10 shown in FIG. 1 is installed in, for example, a moving object such as a vehicle and detects the position of an object near the moving object. The object detection device 10 acquires the azimuth in which the object exists from a first sensor 2 that measures at least the azimuth of an object. The first sensor 2 may be a sensor that can detect the distance between the first sensor 2 and an object in addition to the azimuth of the object. The first sensor 2 is, for example, a monocular camera or a millimeter-wave radar.

The object detection device 10 also acquires, from second sensors 4 that detect the distance to an object, the distances between the object and the second sensors 4. In the first embodiment, the single first sensor 2 and the multiple second sensors 4 are used. In the case that the first sensor 2 can detect the distance between the first sensor 2 and an object in addition to the azimuth of the object, the second sensors 4 can detect the distance to the object with an accuracy higher than the accuracy with which the first sensor 2 can detect the distance to the object. The second sensors 4 are, for example, millimeter-wave radars.

The object detection device 10 is mainly a microcomputer including a CPU, semiconductor memories such as RAM, ROM, and flash memory, and an input-output interface. Hereinafter, the semiconductor memories will also be simply referred to as the memory. The object detection device 10 may incorporate one microcomputer or a plurality of microcomputers.

The object detection device 10 has various functions implemented by the CPU executing programs stored in a non-transient tangible storage medium. In this example, the memory corresponds to the non-transient tangible storage medium in which the programs are stored. When the CPU executes the programs, the methods corresponding to the programs are performed.

The object detection device 10 includes a region measurement unit 12, a region acquisition unit 14, a region determination unit 16, and an object detection unit 18 as components for functions implemented by the CPU executing the programs. The functions implemented by the region measurement unit 12, the region acquisition unit 14, the region determination unit 16, and the object detection unit 18 are described in detail in the following section on processing.

### [1-2. Processing]

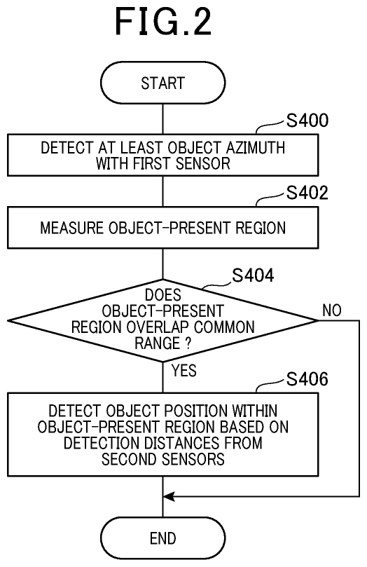

Object detection processing by the object detection device 10 will now be described with reference to the flowchart in FIG. 2.

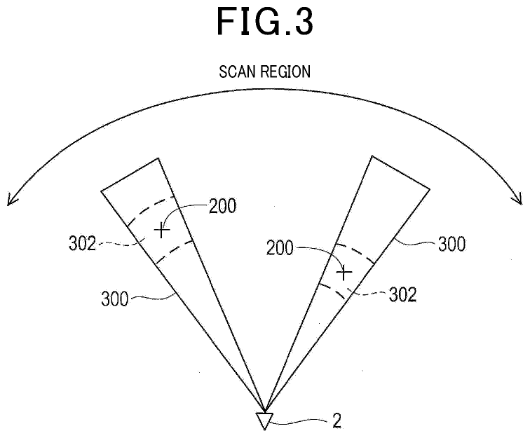

In S400, the first sensor 2, such as a millimeter-wave radar, detects the azimuth in which an object 200 exists by a beam scanning method for, as shown in FIG. 3, scanning a predetermined angular region with a beam at each predetermined scanning angle.

In S402, the region measurement unit 12, as shown in FIG. 3, takes into account an error in the azimuth detected by the first sensor 2 relative to the azimuth detected by the first sensor 2 in which the object 200 exists, and measures an azimuth range in which the object 200 exists, as an object-present region 300 in which the object 200 exists. When a plurality of objects 200 exist, a plurality of object-present regions 300 are measured.

In the case that the first sensor 2 can also detect a distance, an error in the distance detected by the first sensor 2 is taken into account to measure a distance region, and the overlapping region indicated by dotted lines between the azimuth range and the distance region may be measured as an object-present region 302.

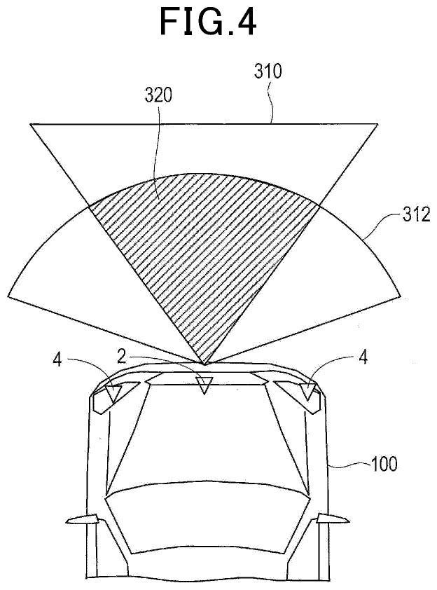

In S404, the region acquisition unit 14, as shown in FIG. 4, acquires a common region 320 that is the overlap between a detection region 310 in which the first sensor 2 can detect the position of an object 200, and a detection region 312 in which the second sensors 4 can detect the position of an object 200.

In the detection region 310 of the first sensor 2, the maximum region in the distance direction from the first sensor 2 to an object 200 refers to the limits within which the first sensor 2 can detect the azimuth of an object. The common region 320, for example, has a distance region of 0 to 100 m and an angular region of −45° to 45°.

The common region 320 may be prestored in the ROM or the flash memory or set based on the detection region in which the first sensor 2 and the second sensors 4 can actually detect an object.

Next, in S404, the region determination unit 16 determines whether the object-present region 300 measured by the region measurement unit 12 overlaps with the common region 320 acquired by the region acquisition unit 14. In the case that the first sensor 2 can also detect a distance, the region determination unit 16 determines whether the object-present region 302 measured by the region measurement unit 12 is included in the common region 320 acquired by the region acquisition unit 14.

If the determination result in S404 is no, or the object-present region 300 measured by the region measurement unit 12 and the common region 320 do not overlap each other, this processing comes to an end. In the case that the first sensor 2 can also detect a distance, if the determination result in S404 is no, or the object-present region 302 measured by the region measurement unit 12 is not included in the common region 320, this processing comes to an end.

In this case, within the overall detection region 312 of the second sensors 4, the position of the object is detected, for example, based on three-sided positioning using the distances between the object and the second sensors 4 detected by the second sensors 4. When the three-sided positioning suggests that a plurality of object candidates exist within the region of estimated one object, positioning processing is executed to determine whether to determine the position of a group of more candidates as the position of the object or determine the gravity center position of the plurality of candidates as the position of the object.

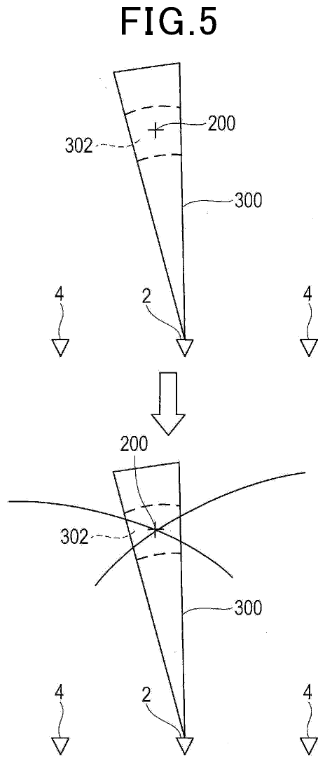

If the determination result in S404 is yes, or the object-present region 300 measured by the region measurement unit 12 and the common region 320 overlap each other, in S406, the object detection unit 18, as shown in FIG. 5, detects the position of the object within the object-present region 300, for example, based on three-sided positioning using the distances between the object and the second sensors 4 in accordance with the detection results from the second sensors 4. In the same manner as described above, when a plurality of object candidates exist within the region of estimated one object, the positioning processing described above is performed.

Even when the object-present region 300 and the common region 320 overlap each other, the object-present region 300 may have a region that does not overlap the common region 320. In this case, the object detection unit 18 detects the position of the object within the overlapping region of the object-present region 300 and the common region 320, for example, based on three-sided positioning and the positioning processing described above using the distances between the object and the second sensors 4. When the object exists in the region of the object-present region 300 that does not overlap the common region 320, or outside the common region 320, the object detection unit 18 cannot detect the position of the object.

In the case that the first sensor 2 can also detect a distance, if the determination result in S404 is yes, or the object-present region 302 measured by the region measurement unit 12 is included in the common region 320, in S406, the object detection unit 18, as shown in FIG. 5, detects the position of the object within the object-present region 302, for example, based on three-sided positioning and the positioning processing described above using the distances between the object and the second sensors 4 in accordance with the detection results from the second sensors 4.

### [1-3. Effects]

The first embodiment described above enables the following advantageous effects to be achieved.

(1a) Based on the detection result from the first sensor 2, the object-present region 300 or the object-present region 302 in which an object exists is measured. Then, when the object-present region 300 overlaps the common region 320 that is the overlap between the detection region 310 of the first sensor 2 and the detection region 312 of the second sensors 4, the position of the object is detected within the object-present region 300 based on the distances to the object 200 detected by the second sensors 4.

In the case that the first sensor 2 can also detect a distance, if the object-present region 302 is included in the common region 320, the position of the object is detected within the object-present region 302 based on the distances to the object 200 detected by the second sensors 4.

This method obviates the need for detecting the position of the object outside the object-present region 300 or the object-present region 302 within the detection region 312 of the second sensors 4 based on the distances detected by the second sensors 4. This allows a reduction in the processing load of detecting the position of the object based on the distances detected by the second sensors 4.

### 2. Second Embodiment

[2-1. Differences from First Embodiment]

A second embodiment is basically similar to the first embodiment, and thus differences will now be described. The same reference numerals as in the first embodiment represent the same components and refer to the preceding description.

In the above first embodiment, when the object-present region 300 overlaps the common region 320 that is the overlap between the detection region 310 of the first sensor 2 and the detection region 312 of the second sensors 4, the position of the object is detected within the object-present region 300.

In the case that the first sensor 2 can also detect a distance, if the object-present region 302 is included in the common region 320, the position of the object is detected within the object-present region 302.

In the second embodiment, when the object-present region 300 and the common region 320 overlap each other, the object-present region 300 is divided into a mesh with its division units referred to as cells. The cell in which the object is more likely to exist than in the surrounding cells is detected as the position of the object. In this respect, the second embodiment is different from the first embodiment.

In the case that the first sensor 2 can also detect a distance, if the object-present region 302 is included in the common region 320, the object-present region 302 is divided into a mesh with its division units referred to as cells. The cell in which the object is more likely to exist than in the surrounding cells is detected as the position of the object. In addition, in this respect, the second embodiment is different from the first embodiment.

A description of the first sensor 2 that can also detect a distance would duplicate that of the first sensor 2 that cannot detect a distance, and thus the case of the former first sensor 2 will be shown but not described.

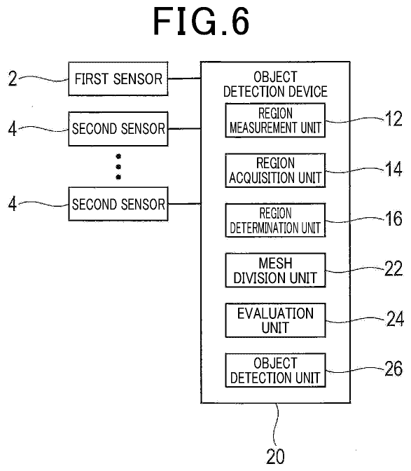

An object detection device 20 shown in FIG. 6 according to the second embodiment includes a region measurement unit 12, a region acquisition unit 14, a region determination unit 16, a mesh division unit 22, an evaluation unit 24, and an object detection unit 26.

### [2-2. Processing]

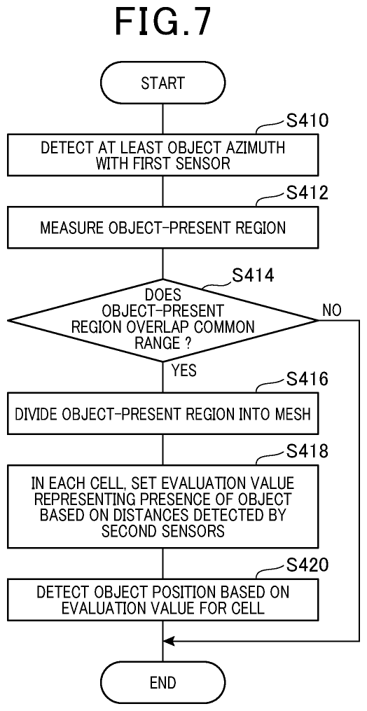

Object detection processing by the object detection device 20 will now be described with reference to the flowchart in FIG. 7.

The processing of S410 to S414 is substantially the same as the processing of S400 to S404 shown in FIG. 2 according to the first embodiment, and will thus not be described.

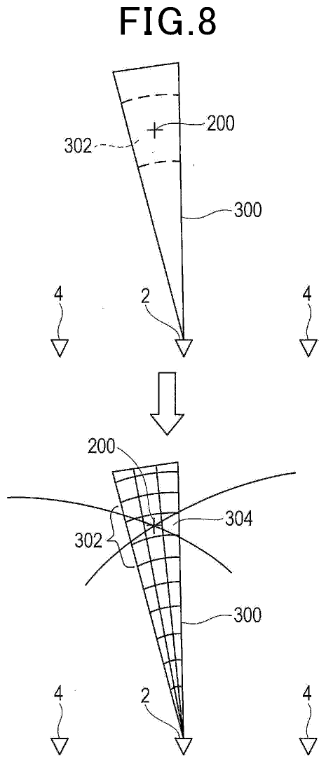

In S416, the mesh division unit 22 divides the object-present region 300 into a mesh having a plurality of fan-shaped cells 304, for example, as shown in the lower part of FIG. 8. The sizes of the cells 304 are determined as appropriate by, for example, the required accuracy of object position detection. Division into smaller cells 304 increases the accuracy of object position detection. However, the sizes of the cells 304 are set within the accuracy of the distance detected by the second sensors 4.

The evaluation unit 24 sets evaluation values representing the likelihoods of an object existing in the cells 304. The evaluation unit 24 first calculates, for each cell 304, the distance error detected by the second sensors 4 between the object 200 and the second sensors 4. The distance errors calculated by the evaluation unit 24 for the cells 304 shown in FIG. 8 will now be described.

First, the number of second sensors 4 is denoted by Ns, the number of objects is denoted by No, the number of divisions of the object-present region 300 in the distance direction is denoted by Nr, the length of a cell 304 in the distance direction is denoted by Δr, the indexes of the cells 304 in the distance direction are denoted by nr=1, . . . , Nr, the number of divisions of the object-present region 300 in the angular direction is denoted by Np, the angle of a cell 304 in the angular direction is denoted by Δp, the indexes of the cells 304 in the angular direction are denoted by np=1, . . . , Np, the indexes of the second sensors 4 are denoted by n=1, . . . , Ns, the distances to the No objects detected by the n-th second sensor 4 are denoted by Rn=(rn1, . . . , rnNo), and the coordinates of the n-th second sensor 4 are denoted by L radar_n=(xn, yn).

The coordinates L mesh (nr, np) of the cell 304 with an index (nr, np) are expressed by equation (1) below.

[Math. 1]

Lₘₑₛₕ(nᵣ,nₚ)=(nᵣΔr cos(nₚΔp),nᵣΔr sin(nₚΔp)) (1)

The distance between each second sensor 4 and each cell 304, or r mesh (nr, np, n), is expressed by equation (2) below.

[Math. 2]

rₘₑₛₕ(nᵣ,nₚ,n)={square root over (sum((Lₘₑₛₕ(nᵣ,nₚ)−L_{radar}_{_{−N}})²)} (2)

Math. (2) indicates the square root of the sum of the square of the difference between the xy coordinates of each second sensor 4 and the xy coordinates of each cell 304.

Next, at a cell 304 with an index (nr, np), the minimum distance error δ(nr, np, n) representing the minimum difference between each of the distances to a plurality of objects detected by the n-th second sensor 4, Rn=(rn1, . . . , rnNo), and the distance between the cell 304 and the n-th second sensor 4, r mesh (nr, np, n), is calculated from equation (3) below.

[Math. 3]

δ(nᵣ,nₚ,n)=min(rₘₑₛₕ(nᵣ,nₚ,n)−Rₙ) (3)

Then, the distance error ε(nr, np) at each cell 304, which is the total of the minimum distance errors of all the second sensors 4 calculated by equation (3) for the cell 304, is calculated from equation (4) below.

$$\begin{matrix}[ Math . 4 ] & \\ ɛ ( {n}_{r} , {n}_{P} ) = {\sum }_{n = 1}^{{N}_{s}} δ ( {n}_{r} , {n}_{p} , n ) & ( 4 )\end{matrix}$$

A smaller distance error ε(nr, np) expressed by equation (4) represents a higher likelihood of an object existing in the cell 304.

The present inventors have conducted research and as a result, found that the distance error represented by equation (4) has a high accuracy in the distance direction with respect to the second sensors 4, whereas the distance error has a low accuracy in the azimuth direction, or the angular direction, with respect to the second sensors 4.

Thus, the evaluation unit 24 uses equation (5) below to calculate, at each cell 304, the distance variance σ(nr, np) representing the variance of the minimum distance errors δ(nr, np, n) calculated by equation (3). In equation (5), E(δ(nr, np)) represents the mean of the minimum distance errors for the plurality of second sensors 4 at each cell 304.

$$\begin{matrix}[ Math . 5 ] & \\ σ ( {n}_{r} , {n}_{p} ) = {\sum }_{n = 1}^{{N}_{s}} \frac{{( δ ( {n}_{r} , {n}_{p} , n ) - E ( δ ( {n}_{r} , {n}_{p} ) ) )}^{2}}{{N}_{s}} & ( 5 )\end{matrix}$$

A smaller distance variance σ(nr, np) expressed by equation (5) represents a higher likelihood of an object existing in the cell 304.

The present inventors have conducted research and as a result, found that the distance variance represented by equation (5) has a high accuracy in the angular direction with respect to the second sensors 4, whereas the distance variance has a low accuracy in the distance direction with respect to the second sensors 4.

Next, the distance error and the distance variance are added together. When the distance error and the distance variance are added together, erroneous object detection is to be prevented. To do so, at each cell 304, when the distance error is greater than the value Δr/Ns obtained by dividing the length Δr of the cell 304 in the distance direction by the number of second sensors 4, the distance error at the cell 304 is set at infinity.

Furthermore, at each cell 304, when the distance variance is greater than the value Δr/σth obtained by dividing the length Δr of the cell 304 in the distance direction by a predetermined divisor σth, the distance variance at the cell 304 is set at infinity. The divisor σth is set empirically in accordance with the degree of prevention of erroneous detection. A greater divisor σth is more likely to prevent erroneous object detection, but may cause a failure to detect the position of an existing object.

The evaluation unit 24 calculates the sum of the distance error and the distance variance, and sets the resultant value as an evaluation value representing the likelihood of an object existing in the cell 304. The object detection unit 26 then extracts, from the object-present region 300, the cell 304 having a peak evaluation value higher than the evaluation values of the surrounding cells 304 positioned, for example, in front and behind in the distance direction and right and left in the angular direction.

In the second embodiment, the object detection unit 26 extracts the cell 304 having a peak evaluation value lower than the evaluation values of the surrounding cells 304 from the object-present region 300.

The distance error and the distance variance may be added together after being weighted in accordance with the emphasis on the accuracy of the distance error and the distance variance. For example, when the azimuth accuracy is emphasized more than the distance accuracy, the distance variance representing the azimuth accuracy may be set a value greater than the value calculated from equation (5) before the addition of the distance error and the distance variance.

The likelihood of erroneous object detection is higher in the angular direction than in the distance direction with respect to the second sensors 4. Thus, the evaluation unit 24 desirably determines the surrounding cells 304, the evaluation values of which are compared with the peak evaluation value of the cell 304, so that the number of cells 304 in the angular direction is greater than the number of cells 304 in the distance direction. For example, when one cell 304 is positioned in front and one is behind in the distance direction, two cells 304 are positioned right and two are left in the angular direction.

The object detection unit 26 determines the presence of an object at the extracted cell 304 having the peak evaluation value.

### [2-3. Effects]

The second embodiment described above enables the following advantageous effects to be achieved in addition to the effects of the first embodiment described above.

(2a) The distance error having a high accuracy in the distance direction in which an object exists but a low accuracy in the angular direction, and the distance variance having a high accuracy in the angular direction in which an object exists but a low accuracy in the distance direction are added together to set an evaluation value representing the likelihood of the object existing. This enables a cell 304 having a high likelihood of the presence of the object to be extracted with high accuracy both in the distance direction and the angular direction.

This method enables the position of an object existing in the object-present region 300 to be detected with high accuracy based on the detection results from the second sensors 4 for measuring a distance.

(2b) At each cell 304, when the distance error is greater than the value Δr/Ns obtained by dividing the length Δr of the cell 304 in the distance direction by the number of second sensors 4, the distance error at the cell 304 is set at infinity. When the distance variance is greater than the value Δr/σth obtained by dividing the length Δr of the cell 304 in the distance direction by the predetermined divisor 6th, the distance variance at the cell 304 is set at infinity. This enables determination that no object exists in the cell 304 set at infinity, thus preventing erroneous object detection.

### 3. Third Embodiment

[3-1. Differences from Second Embodiment]

A third embodiment is basically similar to the second embodiment, and thus differences will now be described. The same reference numerals as in the second embodiment represent the same components and refer to the preceding description.

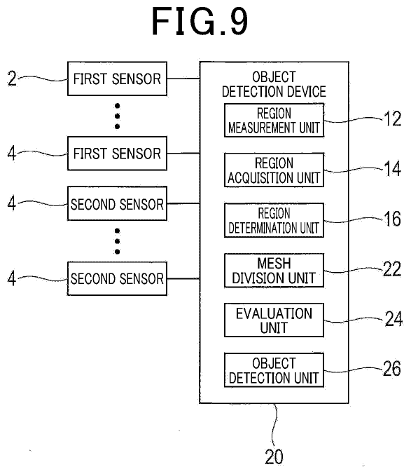

In the above second embodiment, the single first sensor 2 is used. The third embodiment is different from the second embodiment in that as shown in FIG. 9, a plurality of first sensors 2 are used. In the third embodiment, the use of three first sensors 2 is described as an example.

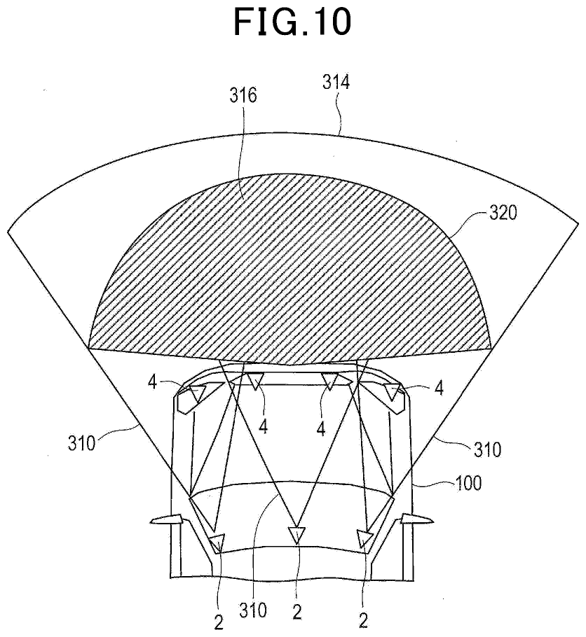

As shown in FIG. 10, the three first sensors 2 are installed to be farther from the object than the second sensors 4 are. This is intended to maximize the common region 320 that is the overlap between a detection region 314 obtained by combining the detection regions 310 within which the three first sensors 2 can detect an object and a detection region 316 within which four second sensors 4 can detect an object. In FIG. 10, the detection region 316 within which the second sensors 4 can detect an object corresponds substantially to the common region 320.

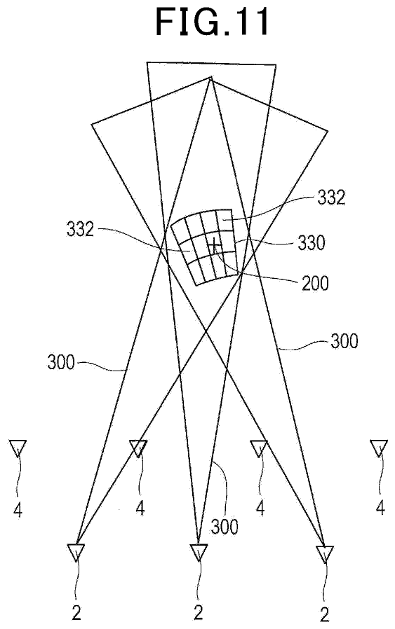

As shown in FIG. 11, even for a first sensor 2 that can detect an azimuth but cannot detect a distance, the use of a plurality of such first sensors 2 enables the region measurement unit 12 to measure, as an object-present region 330, the overlapping region of the object-present regions 300 defined based on the detection results from the first sensors 2.

The object-present region 330 is divided into a mesh having a plurality of fan-shaped cells 332. Each cell 332 has the same angular width and also the same length in the distance direction from the second sensors 4 to an object.

In the case that the first sensors 2 can also detect a distance, the overlapping area of the object-present regions 302 described in the first embodiment and the second embodiment, which is the overlap between the object azimuth ranges and the object distance regions detected by the plurality of first sensors 2, can be defined as the object-present region 330.

### [3-2. Effects]

The third embodiment described above enables the following advantageous effects to be achieved in addition to the effects of the second embodiment.

(3a) The installation of the plurality of first sensors 2 to be farther from the object than the second sensors 4 are enables the maximization of the common region 320 that is the overlap between the detection region 314 obtained by combining the detection regions 310 within which the first sensors 2 can detect an object and the detection region 316 within which the plurality of second sensors 4 can detect an object.

(3b) Even for a first sensor 2 that can detect an azimuth but cannot detect a distance, the use of a plurality of such first sensors 2 enables the region measurement unit 12 to measure, as the object-present region 330, the overlapping region of the object-present regions 300 measured based on the detection results from the first sensors 2. The resulting object-present region is narrower than the region of a single first sensor 2. This allows a reduction in the processing load of detecting the position of the object within the object-present region based on the object distances detected by the second sensors 4.

### 4. Fourth Embodiment

[4-1. Differences from Third Embodiment]

A fourth embodiment is basically similar to the third embodiment, and thus differences will now be described. The same reference numerals as in the third embodiment represent the same components and refer to the preceding description.

In the third embodiment described above, the object-present region 330 is divided into a mesh having cells 332 with the same angular width and the same length in the distance direction from the second sensors 4 to an object.

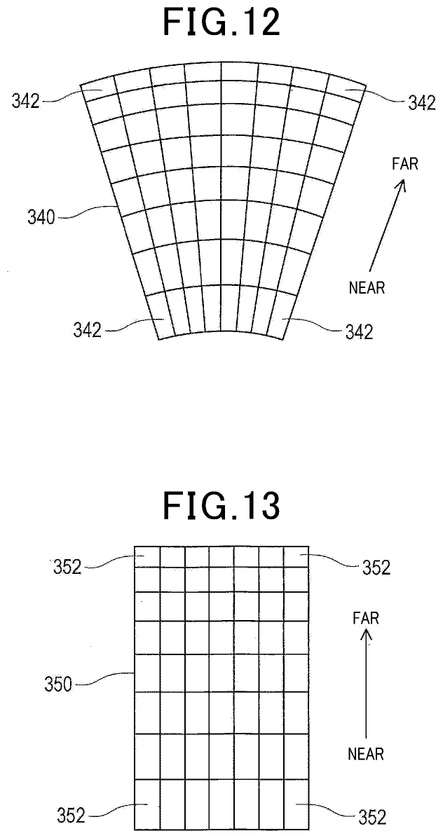

In the fourth embodiment, as shown in FIG. 12, within a fan-shaped object-present region 340 measured based on the detection results from the first sensors 2, the length of a cell 342 in the distance direction from the second sensors 4 to an object is inversely proportional to the distance between the second sensors 4 and the cell 342. In other words, cells 342 become shorter in the distance direction with increasing distance from the second sensors 4. In the fourth embodiment, each cell 342 has the same angular width.

This is because the accuracy in the distance detection decreases with increasing distance from the second sensors 4. Cells 342 farther from the second sensors 4 are made shorter in the distance direction to prevent a reduction in the distance accuracy at cells 342 far from the second sensors 4.

For a quadrangular object-present region 350 shown in FIG. 13, cells 352 have the same length in the lateral direction orthogonal to the distance direction. The length of a cell 352 in the distance direction is inversely proportional to the distance between the second sensors 4 and the cell 352. In other words, cells 352 become shorter in the distance direction from the second sensors 4 to an object with increasing distance from the second sensors 4.

### [4-2. Effects]

The fourth embodiment described above enables the following advantageous effects to be achieved in addition to the effects of the third embodiment.

(4a) In the object-present regions 340 and 350, the cells 342 and 352 are made shorter in the distance direction with increasing distance from the second sensors 4 to prevent a reduction in the distance accuracy at cells 342 and 352 far from the second sensors 4.

(4b) The structure with the cells 342 and 352 shorter with increasing distance from the second sensors 4 can prevent an increase in the processing load on object detection compared with a structure in which all the cells 342 and 352 in the object-present regions 340 and 350 are shorter in the distance direction.

### 5. Fifth Embodiment

[5-1. Differences from Fourth Embodiment]

A fifth embodiment is basically similar to the fourth embodiment, and thus differences will now be described. The same reference numerals as in the fourth embodiment represent the same components and refer to the preceding description.

In the fourth embodiment described above, the cells 342 within the object-present region 340 have the same angular width with the length of each cell 342 being inversely proportional to the distance between the second sensors 4 and the cell 342 in the distance direction, irrespective of the distance between the second sensors 4 and the object-present region 340.

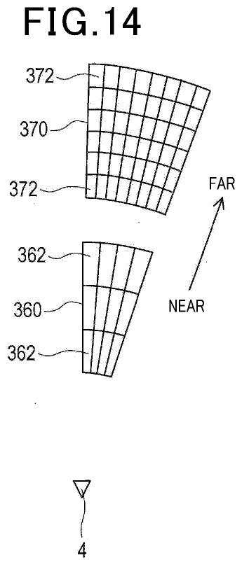

In the fifth embodiment, as shown in FIG. 14, cells 362 and cells 372 have different angular widths, and the cells 362 and the cells 372 have different lengths in the distance direction in accordance with the distances between the second sensors 4 and object-present regions 360 and 370.

In the object-present region 370 farther from the second sensors 4, the cells 372 have the smaller angular width, and also the cells 372 also have the smaller length in the distance direction.

This is because the accuracy in the distance detection by the second sensors 4 decreases with increasing distance from the second sensors 4. The cells 372 in the object-present region 370 farther from the second sensors 4 are made shorter in the distance direction to prevent a reduction in the distance accuracy at the cells 372 far from the second sensors 4.

Additionally, in FIG. 14, the object-present region 370 farther from the second sensors 4 has a smaller angular width since the accuracy of detection by the second sensors 4 in the angular direction decreases with increasing distance from the second sensors 4.

However, in the object-present region 360, each cell 362 has the same angular width, and also each cell 362 has the same length in the distance direction. In addition, in the object-present region 370, each cell 372 has the same angular width, and each cell 372 has the same length in the distance direction.

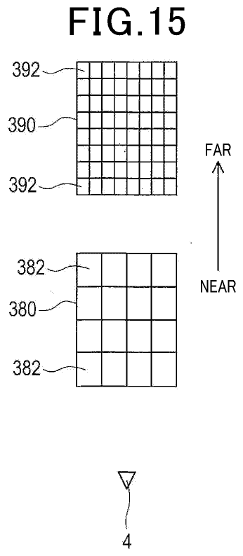

In addition, in a quadrangular object-present region 380 shown in FIG. 15, its cells 382 have the same lateral length, and also the cells 382 have the same length in the distance direction. In addition, in an object-present region 390, its cells 392 have the same lateral length, and also the cells 392 have the same length in the distance direction.

However, the cells 392 within the object-present region 390 farther from the second sensors 4 have the smaller lateral length, and the cells 392 also have the smaller length in the distance direction.

### [5-2. Effects]

The fifth embodiment described above enables the following advantageous effects to be achieved in addition to the effects of the fourth embodiment.

(5a) For the object-present regions 360 and 370, or the object-present regions 380 and 390, the cells 372, 392 in the object-present region 370, 390 farther from the second sensors 4 have the smaller length in the distance direction, with the cells 372 having a smaller angular width or the cells 392 having the smaller lateral length. This structure can prevent a reduction in the distance accuracy and the angular accuracy or the lateral accuracy at the cells 372, 392 far from the second sensors 4.

In other words, the cells 362, 382 in the object-present region 360, 380 nearer to the second sensors 4 have the greater length in the distance direction, with the greater angular width or the greater lateral length. This structure can prevent an increase in the processing load for object detection.

### 6. Other Embodiments

Although embodiments of the present disclosure have been described, the present disclosure is not limited to the above embodiments and may be modified variously.

(6a) In the above embodiments, millimeter-wave radars are used as the second sensors 4 for detecting the distance to an object. Instead of the millimeter-wave radars, LiDAR or sonar may be used as long as the second sensors emit a probe wave to detect the distance to an object.

(6b) The object detection device 10 or 20 may be installed in a moving object other than a vehicle. The object detection device 10 or 20 may be installed in a moving object such as a bicycle, a wheelchair, or a robot.

(6c) The object detection device 10, 20 may be installed not in a moving object but on a fixed position such as a stationary object.

(6d) The object detection device 10, 20 and the technique thereof described in the present disclosure may be implemented by a special purpose computer including memory and a processor programmed to execute one or more functions embodied by computer programs. Alternatively, the object detection device 10, 20 and the technique thereof described in the present disclosure may be implemented by a special purpose computer including a processor formed of one or more dedicated hardware logic circuits. Alternatively, the object detection device 10, 20 and the technique thereof described in the present disclosure may be implemented by one or more special purpose computers including a combination of memory and a processor programmed to execute one or more functions and a processor formed of one or more hardware logic circuits. The computer programs may be stored in a non-transitory, tangible computer readable storage medium as instructions executed by a computer. The technique for implementing the functions of the components included in the object detection device 10, 20 may not necessarily include software, and all the functions may be implemented by one or more pieces of hardware.

(6e) A plurality of functions of one component in the above embodiments may be implemented by a plurality of components, or one function of one component may be implemented by a plurality of components. A plurality of functions of a plurality of components may be implemented by one component, or one function implemented by a plurality of components may be implemented by one component. Some components in the above embodiments may be omitted. At least some components in one of the above embodiments may be added to or substituted for components in another of the above embodiments.

(6f) In addition to the object detection device 10, 20 described above, the present disclosure may be implemented in various forms such as a system including the object detection device 10, 20 as a component, an object detection program that allows a computer to function as the object detection device 10, 20, a storage medium storing the object detection program, and an object detection method.

What is claimed is:

1. An object detection device comprising:
a region measurement unit configured to, based on a detection result from at least one first sensor for detecting at least an azimuth of an object, measure at least an azimuth range in which the object exists, as an object-present region in which the object exists;
a region acquisition unit configured to acquire a common region being an overlap between a detection region allowing the first sensor to detect a position of the object and a detection region allowing a plurality of second sensors for detecting a distance to an object to detect the position of the object;
a region determination unit configured to determine whether the object-present region measured by the region measurement unit and the common region acquired by the region acquisition unit overlap each other; and
an object detection unit configured to, in response to the region determination unit determining that the object-present region and the common region overlap each other, detect the position of the object within the object-present region based on distances detected by the second sensors between the second sensors and the object.

2. The object detection device according to claim 1, wherein
the first sensor is configured to detect a distance between the first sensor and the object in addition to the azimuth in which the object exists,
the region measurement unit is configured to, based on the detection result from the first sensor, measure the object-present region using the azimuth range and a distance region between the first sensor and the object,
the region determination unit is configured to determine whether the object-present region is included in the common region, and
the object detection unit is configured to, in response to the region determination unit determining that the object-present region is included in the common region, detect the position of the object within the object-present region based on distances detected by the second sensors between the second sensors and the object.

3. The object detection device according to claim 1, wherein
the second sensors detect the distances with accuracy higher than accuracy with which the first sensor detects the distance.

4. The object detection device according to claim 1, further comprising:
a mesh division unit configured to divide the object-present region into a mesh having a plurality of cells; and
an evaluation unit configured to, based on distances detected by the second sensors between the second sensors and the object, set an evaluation value representing a likelihood of the object existing in each of the cells,
wherein the object detection unit is configured to, based on the evaluation value set by the evaluation unit, determine for each of the cells whether the object exists.

5. The object detection device according to claim 4, wherein
the evaluation unit is configured to, in each of the cells, calculate a minimum distance error representing a minimum difference between a distance to the object detected by each of the second sensors and a distance between the cell and each of the second sensors, calculate a total of the minimum distance errors associated with the second sensors and a variance of the minimum distance errors associated with the second sensors in each of the cells, and set the total of the minimum distance errors and the variance of the minimum distance errors as the evaluation value, and
the object detection unit is configured to, based on the evaluation value being the total of the minimum distance errors and the variance of the minimum distance errors, determine for each of the cells whether the object exists.

6. The object detection device according to claim 1, wherein
the first sensor is installed to be farther from the object than the second sensors are.
